(19) United States
(12) Patent Application Publication
(10) Pub. No.: US 2011/0091607 A1
(43) Pub. Date: Apr. 21, 2011

(54) METHOD AND SYSTEM FOR PROCESSING GLACIAL WATER

(76) Inventor: Allen Szydlowski, Santiago (CL)

(21) Appl. No.: 12/905,590

(22) Filed: Oct. 15, 2010

Related U.S. Application Data
(60) Provisional application No. 61/251,912, filed on Oct. 15, 2009.

(51) Int. Cl. E03B 3/04; E03B 1/00; A23L 2/00

(52) U.S. Cl. 426/66; 210/747

(57) ABSTRACT

Methods and systems for recovering, and processing ice obtained from an ice source, i.e., a glacier, ice sheet, ice cap, etc., are described herein. In particular, the ice obtained from the ice source holds unique properties and is processed as a beverage for consumption having unique properties. Further, the resulting product is produced with minimal human alteration and reduced energy input as compared to conventional methods for packaging water.

### CROSS REFERENCE TO RELATED APPLICATIONS

This Application claims the benefit of U.S. Provisional Application No. 61/251,912, filed Oct. 15, 2009, the entire disclosure of which is hereby incorporated herein by reference.

### FIELD OF THE INVENTION

The present invention relates generally to a method and system for obtaining and preparing drinking water derived from an ice sheet or glacial body. More specifically, it relates to the procurement of glacial ice and glacial melt-waters, to provide clean, valuable, and potable water having traces of extraterrestrial building blocks of life.

### BACKGROUND OF THE INVENTION

Currently, many methods exist for the purification and desalination of water in order to produce potable and commercially appealing drinking products, such as reverse-osmosis. Many of these processes suffer from the drawbacks of high production costs, resulting carbon emissions from the facilities in which they take place, and a significant level of waste water per volume of resulting potable water. As the demand for clean water increases, these methods have also been criticized for the strain they put on natural aquifers. In coastal regions with groundwater aquifers underlain by saline layers, concerns of saltwater encroachment exist where the over-burdening of freshwater aquifers creates a pressure differential that allows heavy concentrations of salt water to infiltrate the drinking supply.

Purification and desalination of water to remove undesired contents such as harmful bacteria and heavy metals is typically an energy-intensive process. In addition to the raw energy consumption required to produce clean water, it is estimated that at least twice the amount of water is used in the production process than is actually bottled. In other words, one liter of bottled water represents three liters of water consumed. It has also been estimated that tens of millions of barrels of oil were required to generate the energy needed to produce the volume of bottled water consumed in the United States in 2007.

### SUMMARY OF THE INVENTION

A long felt but unsolved need exists for a method and system that can be economically employed to procure waters having some of the above reference positive attributes without including undesired components. These and other needs are addressed by the various embodiments and configurations of the present invention.

Applicant hereby incorporates by reference in its entirety U.S. patent application Ser. Nos. 11/551,125 to Szydlowski, filed on Oct. 19, 2006, 61/303,519 to Szydlowski, filed Feb. 11, 2010, and 61/378,811 to Szydlowski filed Aug. 31, 2010. It is contemplated that various methods, systems, and devices of these references may be utilized in various embodiments of the present invention.

In addition to the numerous environmental concerns surrounding the current methods of procuring potable water, various health concerns are present as well. Concerns over undesirable foreign contents in municipal water supplies have forced many consumers to balance the aforementioned environmental risks with the perhaps more personal and immediate concerns posed by these health risks. Contaminants such as heavy metals, including transition metals, metalloids, lanthanoids, and actinides (e.g. Mercury, Lead, Chromium, etc.), PCBs (polychlorinated biphenyls), and pesticides frequently occur in water supplies of even advanced regions. The primary causes of these contamination concerns, aging water distribution infrastructure and pollution, are significant public works concerns that will require significant time and cost to update and repair.

Many water sources are tainted as a result of their latitudes and relative proximity to industrialized nation's carbon emissions, e.g. mercury from coal and petroleum fired power plants. Accordingly, in a preferred embodiment of the present invention, the selected water source is located in a region that is generally unaffected by pollution from industrialized nations. Glacial ice situated in regions between 15 and 60 degrees south latitude, such as Chilean glaciers, provides desirable sources of ice and water for use in the present invention. Additionally, many natural sources of water contain harmful microorganisms, such as Giardi, which often require energy intensive methods such as boiling or the addition of otherwise undesirable substances such as chlorine to eliminate. These concerns are prevalent even in relatively unpolluted areas as such microorganisms frequently enter the water supply from a wide range of their mammalian hosts. Giardia, which is estimated to infect over 2.5 million people annually, typically results in severe gastrointestinal symptoms causing weight loss, malaise, and fatigue.

In recent years, groundbreaking research has yielded evidence of the existence of microorganisms within terrestrial ice. These microorganisms are theorized to have originated with amino acid-bearing comets that collided with Earth approximately four billion years ago and may have assembled into early proteins and DNA. In 2004, a collection of high speed dust samples taken from the comet Wild-2 by the NASA Stardust probe revealed the existence of glycine, a basic component of proteins, within the comet. The existence of these components in the Wild-2 comet provides much of the basis for the theory that the building blocks for life on Earth were delivered by meteorite and comet impacts. These components have also been found on Earth, preserved in glacial ice in a similar manner as to how they are preserved in frozen comets. It is known that amino acids are crucial elements of life as they form the basis of proteins, which are linear chains of amino acids. Accordingly, credible evidence exists to state a theory that the early origins of life on Earth are present in current polar and non-polar ice sheets.

While the details of the potential health benefits of these amino acids have yet to be evaluated, there exists a viable market for unadulterated drinking water which could reasonably be calculated to contain glycine and primordial building blocks of life. In addition to the commercially appealing aspects of consuming the origins of life itself, glycine is known to produce a sweet taste for humans. It is known that glycine may be manufactured industrially by treating chloroacetic acid with ammonia. However, one of skill in the art will recognize the economic and practical benefits of obtain, distributing, and/or marketing glycine of a naturally occurring form.

It is an object of the present invention to obtain water from naturally occurring sources, where it is naturally filtered by its desirable geographic and topographic surroundings, and ensure purification of the water without pasteurizing, filtering, sanitizing, or otherwise eliminating certain commercially viable contents. In one particular embodiment, glacial water is procured and directed through a conduit system that comprises one or more sections having native Chilean earth components thereto.

It is a further object of the present invention to utilize only natural, non-biological, non-chemical additives to the filtration process of water. In one specific embodiment, filters comprised of natural and native soils are constructed to obtain the appropriate level of purity without adding content to the water or using biological processes. In one embodiment, the natural filtration process of water flowing in, around, or through desirable soils is selectively repeated by diverting natural flow through additional natural or man-made filters at lower elevations. In another embodiment, the natural filtration processes may be aided by the addition of advantageous biologic or chemical substances.

It is a further object of the present invention to obtain water from naturally occurring sources where the gravitational potential energy of the water is utilized in connection with the natural environment to filter and purify the water. In one embodiment, water to be filtered, cleaned, or otherwise used in the present invention is delivered by the force of gravity alone.

It is a further object of the present invention to filter, assess and ensure purity via predetermined criteria, and obtain clean water by channeling glacial water through additional phases of natural filtration through which the water passes largely, if not solely, under gravitational force. This process allows for substantially continuous natural filtration and purification of water without continuous energy consumption from man-made power inputs, resulting in reduced production costs and reduced carbon emissions.

It is a further object of the present invention to implement a filtration and purification process which initially uses source water from strategic geographic locations, such as those regions of Earth that are not generally impacted by carbon emissions and other pollutants produced by industrialized countries due to the physical location of the source and prevailing winds. In a preferred embodiment, the present invention includes a method whereby only water from desirable latitudinal locations of the Earth is selected for filtration and/or processing.

It is yet another object of the present invention to produce safe and healthy drinking water with signature characteristics of the geographic location from which it originated. In certain embodiments, water treated in accordance with the method/system set forth herein may have added to it particular “markers,” or have certain characteristics or “markers” enhanced to provide later evidence and proof of at least one of origin, quality, source, purity, geological formation, treatment regimen, latitudinal characteristics, mineral content, extra territorial content, etc. In such a manner, counterfeiting of legitimate water can be deterred, prevented, and/or investigated.

It is another object of the present invention to procure water for distribution which is of sufficient purity, without being subjected to chemical or biological treatments, that it may be reasonably calculated or asserted to contain amino acids and other compounds that can form the building blocks of life. Furthermore, the present invention contemplates employing known methods for evaluating and detecting the presence of these and other compounds in order to affirmatively establish their presence.

To facilitate best mode and written description concerns, various aspects of how to make and use the present invention can be better understood by referring to the particular prior art systems. For example, U.S. Pat. No. 7,332,082 to Brandlmaier, which is hereby incorporated by reference in its entirety, discloses a chemical-free method of treating and keeping clean water and is hereby incorporated by reference in its entirety. Brandlmaier discloses a method of transporting water to different filter stages by gravity. However, Brandlmaier necessarily involves a biologic filter, such as a planted ground filter, as one phase of the filtration process before optionally returning the water to a swimming facility.

U.S. Pat. No. 7,569,148 to Elefritz, Jr. et al., which is hereby incorporated by reference in its entirety, discloses a method of treating wastewater utilizing sequence batch reactors and membrane filters, and is hereby incorporated by reference in its entirety. Elefritz, Jr. et al. teach a filtration system that requires a biological reactor, thereby requiring additional production costs as compared to the present invention.

U.S. Pat. No. 7,077,963 to McConchie et al., which is hereby incorporated by reference in its entirety, discloses a process for treating acidic water containing dissolved organic solvents. McConchie et al. fails to teach a method for treating water that does not require the addition of substances. In this manner, McConchie et al. fails to teach at least some of the novel aspects of the present invention.

U.S. Pat. No. 5,032,261 to Pyper, which is hereby incorporated by reference in its entirety, discloses a system for filtering bacteria and preparing drinking water. Pyper discloses a system that includes biological filtration and does not rely upon gravity as a source of energy input.

U.S. Pat. No. 4,564,450 to Piper et al. which is hereby incorporated by reference in its entirety, discloses a modular array of filter elements for treating water. Piper et al. disclose a quadrilateral module. Accordingly, Piper et al. teach away from aspects of the present invention which are not confined to quadrilateral arrays.

United States Patent Application Publication No. 2009/0230061 to Mitchell et al., which is hereby incorporated by reference in its entirety, discloses a method for filtering and removing bacteria from water. Mitchell et al. disclose a system that involves a filter housing comprising mesoporous activated carbon. Mitchell et al. fail to teach novel aspects of the present invention. As one of ordinary skill in the art will appreciate, various aspects of the above systems can be employed in practicing different embodiments of the present invention.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below.

### BRIEF DESCRIPTION OF THE DRAWINGS

FIG. 1 is a plan view of a natural glacial melt water filtration system, utilizing gravity and additional geologic structural members to provide thorough filtration;

FIG. 2 is a plan view of an embodiment of the present invention using multiple iterations of natural filtration for glacial melt waters;

FIG. 3 is a top view of an embodiment of the present invention where glacial ice or water may be selectively diverted through various filters.

FIG. 4 is a flowchart illustrating one embodiment of the present invention where natural potable water is obtained from glacial ice.

FIG. 5 depicts an exemplary final product in accordance with embodiments of the present invention.

### DETAILED DESCRIPTION OF PREFERRED EMBODIMENTS

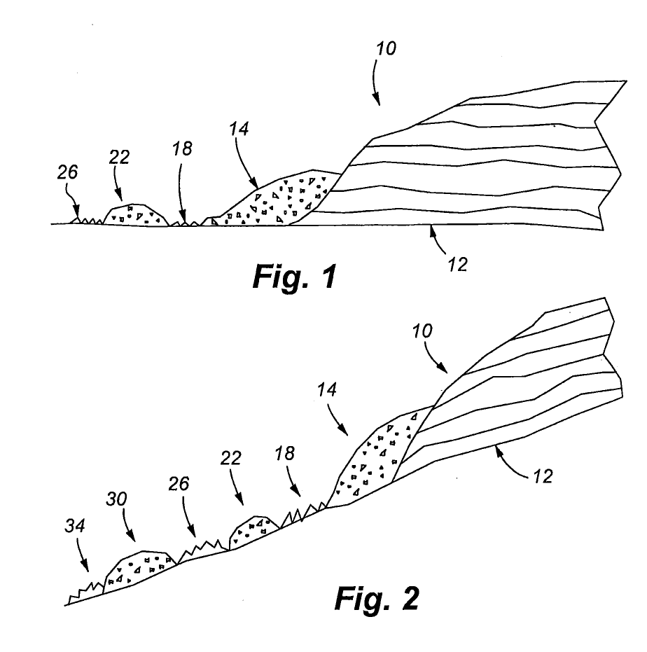

FIG. 1 is a plan view of glacial ice and melt water 12 as it is subjected to colloidal clay filtering. One aspect of the present invention is that the source water 10 is of a high degree of purity at the beginning of the process. With respect to the present invention, a high degree of purity refers to an ice or water source that is substantially free of harmful contaminants. While it will be recognized that certain contaminants may be more or less harmful to different individuals, substantially free of harmful contaminants with the respect to the present invention means that the source contains such a low level of contaminants as to not cause illness or harm to an adult human when up to 128 fluid ounces are consumed on a daily basis. By selecting a water source of sufficient initial purity, natural and organic filtering can be applied to produce high quality potable water without the use of sterilization chemicals or energy intensive filtration means.

It is known that soil acts as a natural filter of water. In addition to the mechanical capturing of solid particles, the term filtering in this context also involves retaining chemicals, transforming chemicals, and restricting the movement of certain substances. These acts of filtering are often known as soil attenuation. Soil attenuation includes the ability to immobilize metals and remove bacteria that may be carried into the water through such means as human or mammalian waste. It is further known that fine textured soils, such as clay, provide superior filtration of water when compared to large grained or coarse soils such as sand. Water travels through coarse soils more rapidly, thereby reducing contact between the water and soil and thus reducing filtration or attenuation. Permeability is a typical measure of a soil's ability to transmit water and other fluids. Clay is known to have a relatively low permeability as a result of its small grain size and large surface area, causing increased friction between water transmitting through the clay. Clay may have a permeability, or hydraulic conductivity, as low as 10⁻¹⁰ centimeters per second whereas well sorted sands and gravels typically have a permeability of 10⁻³ to 1 centimeter per second.

The method depicted in FIG. 1 depicts the natural process by which glacial water 18, 26 is filtered through clay deposits 14 under the force of gravity and is further subjected to additional filtering 22 through clay of the same composition that is selectively positioned by the operator of the current invention. In one embodiment of the present invention, the soil used in filtration is of permeability between 1 and 10⁻¹² centimeters per second. In a preferred embodiment, soil used in the filtration has permeability approximately between 10⁻⁵ and 10⁻¹¹ centimeters per second. In a more preferred embodiment, soil is used in the filtration process that has permeability approximately between 10⁻⁸ and 10⁻¹⁰ centimeters per second. This additional phase of clay filtration 22 is selectively implemented by the user to create an additional filtration process in an area with sufficient flow rate.

It will be recognized that this additional clay filter need not be of any particular size. Creation of the appropriate sized filter will largely be determined by the user's needs and the natural flow rate of melt water in the particular setting. By taking advantage of the gravitational potential energy of glaciers, ice caps, and the like, the present invention offers a significant advantage over traditional household and commercial filtration processes, such as reverse osmosis, in that the current process does not require energy input generated from hydrocarbon sources. While it will be recognized that initial construction of additional clay filtration stages 22 may potentially require energy input from hydrocarbon fuels, renewable energy sources including human power, or other input, it is an object of the present invention that these filtration stages will operate under the energy provided by gravitational potential energy and the kinetic energy of ice and water.

FIG. 2 depicts an embodiment of the present invention where a plurality of additional clay filters 22, 30 have been constructed to further filter and purify glacial water. It will be known to one of skill in the art that any number of additional filtration phases may be constructed. Accordingly, the present invention may be accomplished as described herein with any feasible number of filters.

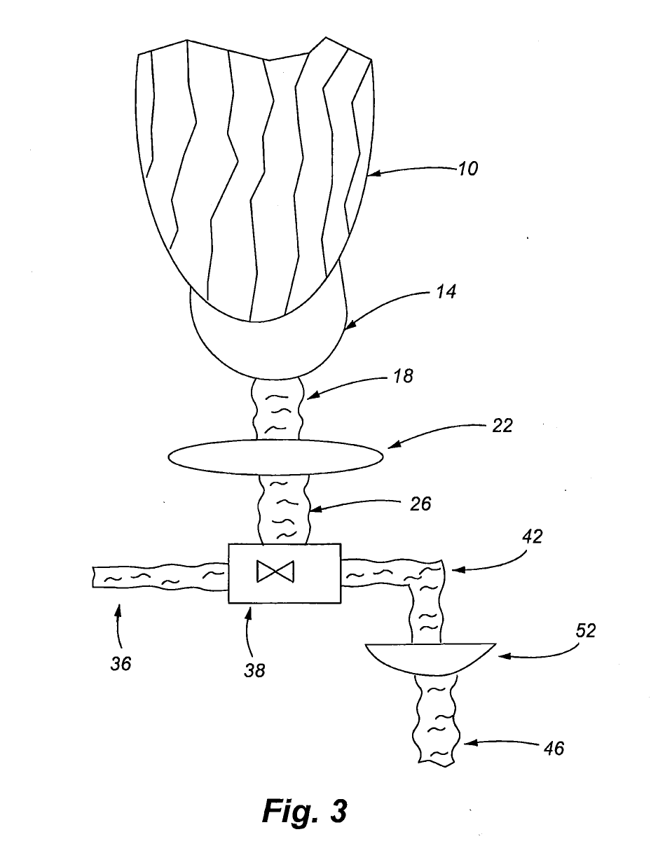

FIG. 3 depicts another embodiment of the present invention where the source ice or water 10 is filtered through natural clay 14, further filtered through a constructed additional clay filter 22, and selectively diverted by a control valve 38 based on whether or not additional filtration is desired. The control valve 38 may be selectively adjusted to divert water and ice 36 that the user does not desire to undergo additional filtration to bottling or processing facilities. Alternatively, the control valve 38 may also be selectively positioned so that water and ice 26 are subjected to further constructed filter iterations 32. The resulting water and ice 46 may then be diverted to processing and bottling facilities, subjected to further filtrations, or subjected to additional control valve and filtration steps as previously described.

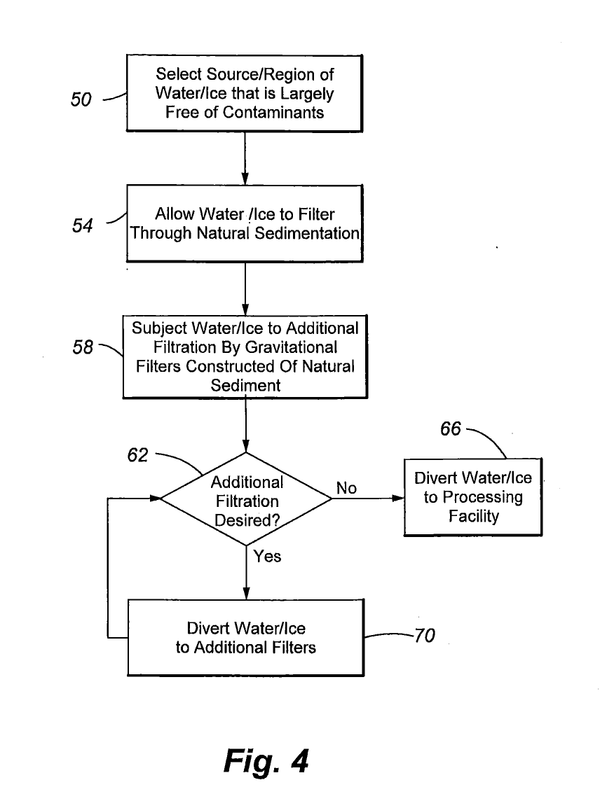

FIG. 4 depicts a flowchart describing one embodiment the present invention. The initial step 50 involves selecting a glacial body or ice cap of sufficient purity. While it will be recognized that many natural sources of water and ice contain some level of impurity, the present invention contemplates a source that is generally untouched by human and/or mammalian beings and located in latitudes where emissions from industrialized nations have very little impact. While the present invention is not limited to application in any particular region, glacial ice and ice caps south of 15 degrees latitude are well suited for this process. Once a water source is identified, the present invention contemplates allowing the glacial ice and melt water to channel naturally through sediment in its surroundings 54. Ideally, this sediment is composed of clay or similar soil which provides a low permeability and naturally filters the water. After this first step of filtration has occurred, the resulting water is then passed through additional man-made sedimentary filters 58. In one embodiment of the present invention, these filters are composed of the same or similar clay-like soil as in process 54. The water may either be selectively diverted to the additional man-made filters, or the filters may be constructed in the natural path of the water. It is a critical feature of the present invention that this sedimentary filtration 54, 58 is powered solely by gravitational forces. One benefit that will be recognized is the reduced or eliminated need to provide energy input to achieve filtration. Decision block 62 involves a determination of whether the water and ice should be subjected to additional sedimentary filters or diverted to a facility for processing and/or bottling. If additional filtration is not desired, the water may be diverted by, for example, a valve 38 to the processing or bottling facility 66. One of ordinary skill in the art will realize that this valve may be comprised of a gate valve, ball valve, globe valve, three-way valve, or any valve suitable for diverting water or ice. If additional filtration is desired, the valve may be selectively positioned to divert the water or ice to additional sedimentary filters of the previously discussed composition 70.

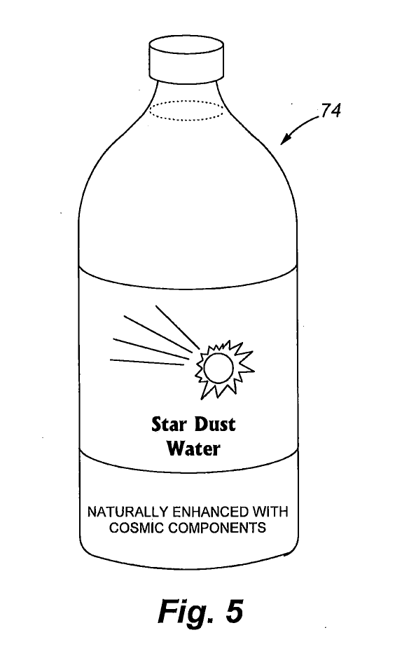

FIG. 5 depicts an exemplary final product 74 of the present invention whereby clean, filtered, potable water is produced without the use of sterilizing chemicals, such as chlorine or iodine, or energy intensive filtration processes. A benefit of the present invention is the ability to produce pure, potable water without destroying, filtering, or eliminating desirable active contents. By filtering the source water by natural sedimentary processes, it is possible to market a product that may contain amino acids, such as glycine and other amino acids traceable to extraterrestrial bodies. With respect to the present invention, extraterrestrial bodies refer to comets, meteors, and other similar bodies. The prospect of producing pure, healthy water with prospect of drinking the original building blocks of life on Earth holds significant commercial appeal.

The foregoing discussion of the invention has been presented for purposes of illustration and description. Further the description is not intended to limit the invention to the form disclosed herein. Consequently, variations and modifications commensurate with the above teachings, within the skill or knowledge of the relevant art, are within the scope of the present invention. The embodiments described above are further intended to explain the best mode presently known of practicing the invention and to enable others skilled in the art to utilize the invention in other embodiments and with various modifications required by their particular application or use of the invention. It is intended that the appended claims be construed to include alternative embodiments to the extent permitted by the prior art. It will be recognized that the steps described herein may be conducted in a variety of sequences without violating the novelty or spirit of the present invention. In one particular embodiment, the present invention is conducted by adhering to a sequence of first selecting a water source substantially free of harmful contaminants, including heavy metals, PCBs, and pesticides, subsequently constructing one or more filters at a point of lower gravitational potential energy than the source, subsequently identifying signature characteristics of the filtered water, and finally packaging the water for distribution.

What is claimed is:

1. A method for preparing water obtained from an ice source, comprising:
selecting an ice source comprising at least 1,000 cubic meters of ice that is substantially free of at least three materials selected from the group consisting of: mercury, lead, arsenic, cadmium, benzene, chlorine, copper, chromium, tetrachloroethylene, trichloroethylene, and uranium;
conducting water from the ice source through a plurality of filtration stages wherein at least one of the plurality of filtration stages comprises clay;
identifying at least three characteristics selected from the group consisting of: origin, quality, source, purity, geological formation, treatment regimen, latitudinal characteristics, mineral content, extra territorial content; and
verifying that the water from the ice source comprises a quantity of glycine.

2. The method of claim 1, wherein in response to the water containing glycine, packaging the water for distribution in containers adapted for displaying information regarding the water's contents.

3. The method of claim 2, wherein the containers are bottles between about 0.1 litres and about 10 litres.

4. The method of claim 1, wherein the conducting step is performed using gravitational energy.

5. The method of claim 1, wherein the conducting step is performed using one or more mechanical energy pumps.

6. The method of claim 1, wherein the glycine comprises naturally occurring glycine.

7. The method of claim 1, wherein the ice source comprises a tidewater glacier.

8. A method for producing bottled water derived from glacial ice, comprising:
a) analyzing a glacial ice source for the presence of glycine;
b) extracting water in at least one of a solid and liquid state from at least a portion of said ice source that is determined to contain glycine, said determination based on said step of analyzing, said step of extracting conducted so as not to contaminate the water;
c) collecting said extracted water;
d) directing said collected water into a container; and
e) providing an indication on said container to reflect a quantity of glycine within said water in said bottle.

9. The method of claim 8, wherein the container is a bottle between about 0.1 litres and about 10 litres.

10. The method of claim 8, wherein the extracting step is performed without the use of devices requiring hydrocarbon-based fuels.

11. The method of claim 8, wherein the extracting step is performed using gravitational energy.

12. The method of claim 8, wherein the analyzing step comprises analyzing the ice source for the presence of natural glycine.

13. A method for preparing water obtained from an ice source, comprising:
selecting an ice source that is substantially free of at least one of: metalloids, lanthanoids, actinides, polychlorinated biphenyls, and pesticides;
constructing one or more filters at a point of lower gravitational potential energy than the source;
wherein the one or more filters comprise a permeability between approximately 10⁻¹⁰ cm/s and approximately 10⁻³ cm/s;
conducting water toward at least one of the filters;
identifying at least three characteristics selected from the group consisting of: origin, quality, source, purity, geological formation, treatment regimen, latitudinal characteristics, mineral content, extra territorial content, within the water by mapping the at least three characteristics to characteristics of the ice source;
wherein the one or more filters comprise clay; and
verifying that the water has one or more characteristics similar to those of water derived from a sub-polar ice field located approximately between 15 and 60 degrees south latitude.

14. The method of claim 13, wherein the characteristics include at least one of the characteristics selected from the group consisting of: purity, mineral content, pH, and acidity.

15. The method of claim 13, wherein the source is evaluated to:
1) identify that the source has a total volume of at least 10,000 cubic meters;
2) determine the presence of glycine in at least a portion of the source; and
wherein water is directed through a filter comprising clay; and
packaging the water containing glycine for distribution.

16. The method of claim 15, wherein the packaging step comprises packing the water for distribution in containers, the containers adapted for displaying information regarding the presence of glycine in the water.

17. The method of claim 13, further comprising packaging water having one or more characteristics similar to those of water derived from a sub-polar ice field located approximately between 15 and 60 degrees south latitude in containers, the containers adapted for displaying information related to the water's characteristics.

18. The method of claim 17, wherein the containers are bottles between about 0.1 litres and about 10 litres.

19. The method of claim 13, wherein the one or more filters comprise a permeability between approximately 10⁻¹⁰ cm/s and approximately 10⁻⁸ cm/s.

20. The method of claim 13, wherein the one or more filters consist essentially of clay.
